(19) United States
(12) Patent Application Publication
(10) Pub. No.: US 2011/0173132 A1
(43) Pub. Date: Jul. 14, 2011

(54) Method and System For Spawning Smaller Views From a Larger View

(75) Inventors: Steven R. ABRAMS, New York, NY (US); Sophia Krasikov, Katonah, NY (US); Ian Simmonds, Hawthorne, NY (US); Emmanuel Yashchin, Yorktown Heights, NY (US)

(73) Assignee: International Business Machines Corporation, Armonk, NY (US)

(21) Appl. No.: 12/685,062

(22) Filed: Jan. 11, 2010

(51) Int. Cl. G06Q 10/00; G06F 17/00

(52) U.S. Cl. 705/348; 706/47

(57) ABSTRACT

A method includes defining a first component set of one or more first components; defining a second component set of one or more second components; and defining an original set of relationships, each relationship being between one component of the first component set and one component of the second component set. The method further includes decomposing the original set of relationships into a collection of view sets, each view set having at least one subset of the original set of relationships where the first and second components are associated with the respective relationships of the subset, and each view set satisfies a set of constraints. The components may be elements of a business model.

### FIELD OF THE INVENTION

The exemplary embodiments of this invention relate generally to graph partitioning in accordance with a set of constraints, and more specifically to the application of graph partitioning to a business model usable by business consultants and other professionals including industry analysts, healthcare consultants, city planners and designers, as several non-limiting examples.

### BACKGROUND

Assisting business clients in streamlining operations, fine-tuning their business goals, and identifying opportunities for internal improvements and investments is a demanding task for business consultants.

A variety of intelligent software supports the efforts of consultants during their engagements with clients. These tools aid consultants and businesses in automating interviews with clients, employees and suppliers, and aid in analyzing information collected during such interviews. These tools can also aid in developing visual presentations of findings, so that consultants can provide recommendations.

A business consultant's work depends on and requires at least the following: knowledge of the business, data generated by that business, and data generated during various interviews with employees and management. Consultants integrate this data into one system for future analysis.

Systems that have historically used a document-centric approach (office tools, for example) offer very limited help to the consultant's creative process, in large part because documents tend to have inconsistency among themselves and because typical document processing software offers little or no support for maintaining consistency within one document or among a set of documents. In addition, typical document processing software provides limited automation (e.g., through a spreadsheet) for the comparison and analysis of collected data.

Recently a model-centric approach has emerged, with different modeling methods being incorporated into different tools. These models are essentially “directed graphs” or “semantic networks” that are manipulated via modeling tools. Visuals in the form of trees, lists, images, and tables presenting the model elements are accessible to consultants and their clients. However, how these visuals display the data can vary widely. In general, whatever form they take those visuals derived from model data tend to be more readily comprehended and manipulated than unstructured data.

### BRIEF SUMMARY

In accordance with an aspect of this invention there is provided a method to create view sets. The method includes defining a first component set of one or more first components; defining a second component set of one or more second components; and defining an original set of relationships, each relationship being between one component of the first component set and one component of the second component set. The method further includes decomposing the original set of relationships into a collection of view sets, each view set having at least one subset of the original set of relationships where the first and second components are associated with the respective relationships of the subset, and each view set satisfies a set of constraints.

In accordance with another aspect of this invention there is provided a system that comprises at least one memory storing a first component set of one or more first components and a second component set of one or more second components. The system further comprises at least one data processor coupled with the at least one memory and configurable in accordance with a stored software program to define an original set of relationships, where each relationship is between one component of the first component set and one component of the second component set. The at least one data processor is further configurable to decompose the original set of relationships into a collection of view sets, where each view set has at least one subset of the original set of relationships, where the first and second components are associated with the respective relationships of the subset, and where each view set satisfies a set of constraints.

In accordance with a further aspect of this invention there is provided a computer-readable memory medium that stores a software program, the execution of which results in performing operations that comprise defining a first component set of one or more first components; defining a second component set of one or more second components; and defining an original set of relationships, each relationship being between one component of the first component set and one component of the second component set. The operations further comprise decomposing the original set of relationships into a collection of view sets, each view set having at least one subset of the original set of relationships where the first and second components are associated with the respective relationships of the subset. Each view set satisfies at least the following constraints: none of the relationships in the original set of relationships is absent from any view set, and each view set has at least one subset of the original set of relationships.

### BRIEF DESCRIPTION OF THE SEVERAL VIEWS OF THE DRAWINGS

The foregoing and other aspects of the teachings of this invention are made more evident in the following Detailed Description, when read in conjunction with the attached Drawing Figures, wherein:

FIG. 1 depicts an exemplary components relationship for an original view of a particular business model.

FIG. 2 shows the original view of a business model with shortened text in cells.

FIG. 3 is a matrix version of the original view of the business model presented in FIGS. 1 and 2.

FIGS. 4A-4J show various spawned smaller views of the matrix representation of FIG. 3.

FIG. 5 illustrates an example of an organizational chart.

FIG. 6 is a simplified block diagram of a data processing system that is suitable for implementing the exemplary embodiments of this invention.

FIG. 7 is a logic flow diagram that is illustrative of a method in accordance with an aspect of this invention.

### DETAILED DESCRIPTION

Embodiments of this invention provide a method, a computer program stored in a memory medium, an apparatus and a system for grouping an original set of relationships into a collection of view sets, where each view set comprises one or more subsets of the original set of relationships.

The embodiments of this invention relate in general to computer-assisted business modeling, and more specifically to grouping relationships into a collection of smaller view sets from a large original view to facilitate comprehension, communication and further manipulation of a model of a business (hereafter referred to as a “business model”).

Different facets of the business model can be visualized via different views. In order to be accessible to a wide range of persons of interest, which may be referred to as “stake-holders”, each view displays a number of complementary and interrelated aspects of the business. Large views, useful for representing an overview of the business as a whole, can provide an overall perspective. However, large views are typically ineffective both in solving a problem and in supporting the communication of findings and recommendations to a client. Smaller views that isolate the interrelations between specific business components are deemed to be more effective in locating and communicating certain aspects of the business, such as the business's weak spots. By supporting the production of smaller views from larger views, this method, and the system that includes it, facilitates the efforts of business consultants both in problem solving and in communicating their findings and recommendations.

The method of grouping relationships into a collection of view sets off of the large original view is a formal process, which takes all model data from a large view as input. The process then constructs new components based on a set of constraints, such as a constraint on dimensions of views in a view set. In one exemplary embodiment the method may store newly created components in the model, along with a reference to the original view. The union of model elements of views in a view set constitutes the full set of model elements of the original view.

The views in a set of views are considered herein as “views-on-the-larger-view”.

The method assumes that the decomposition of the original view may be repeated when the original view is modified, in which case previously created view sets are replaced with newly created ones. However, it is useful to allow previously created view sets to be preserved since a consultant may continue to derive insights from them. While the smaller views in a single view set are derived automatically following precise constraints, they are derived to provoke insights in the mind of the consultant rather than to reveal inherent truths within the model. Usefulness to the consultant may be the primary criterion for whether any given view set is worth preserving.

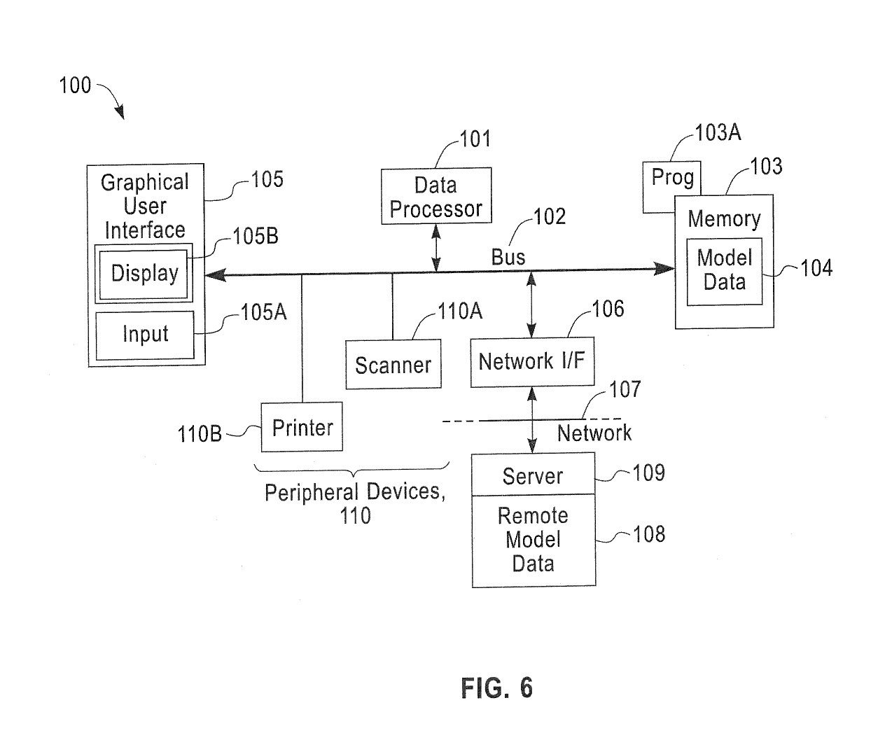

Before describing the exemplary embodiments of this invention in further detail reference is made to FIG. 6 for showing a simplified block diagram of a data processing system 100 that is suitable for use in implementing the exemplary embodiments. The data processing system 100 includes at least one data processor 101 coupled to a bus 102 through which the data processor 101 may address a memory sub-system 103, also referred to herein simply as the memory 103. The memory 103 may include, as examples, RAM, ROM and fixed and removable disks and/or tape. The memory 103 is assumed to store a program (PROG) 103A that contains program instructions for causing the data processor 101 to execute methods in accordance with the exemplary embodiments of this invention. Also stored in the memory 103 is model data 104 which is descriptive of a business or a portion of a business of interest.

The data processor 101 is also coupled through the bus 102 to a user interface, preferably a graphical user interface (GUI) 105 that includes a user input device 105A, such as one or more of a keyboard, a mouse, a trackball, a voice recognition interface, as well as a user display device 105B, such as a high resolution graphical CRT display terminal, an LCD or plasma display terminal, or any suitable display device. The user interface is employed by user, such as a consultant, to interact with the program 103A during the execution of the methods in accordance with this invention, as more fully described below. For example, the display device 105B may be used to visualize the view sets that are created or spawned in accordance with the invention, as described in detail below.

The data processor 101 may also be coupled through the bus 102 to a network interface 106 that provides bidirectional access to a data communications network 107, such as an intranet and/or the interne. Coupled to the network 107 can be one or more sources and/or repositories of (remote) model data 108.

The data processor 101 may also be coupled through the bus 102 to at least one peripheral device 110, such as a scanner 110A and/or a printer 110B.

In general, the embodiments of this invention may be implemented using one or more software programs running on a personal computer, a server, a microcomputer, a mainframe computer, a portable computer, an embedded computer, or by any suitable type of programmable data processor 101.

In an exemplary embodiment of this invention the benefits and advantages may be illustrated on a view presented in the form of a table. The populated cells of the table contain elements of the model related to the corresponding horizontal and vertical header elements of the table (that may be referred to also as a first component set and a second component set), which are in turn elements of the model themselves. Assume that cell elements are “of concern to” the corresponding header elements. The row and the column header elements constitute two groups defined in the model. These two groups correspond to categorization of parties involved in the business model (represented by the model data 104 shown in FIG. 6). The cells in the table, therefore, reflect the state of some interactions between parties in these two groups.

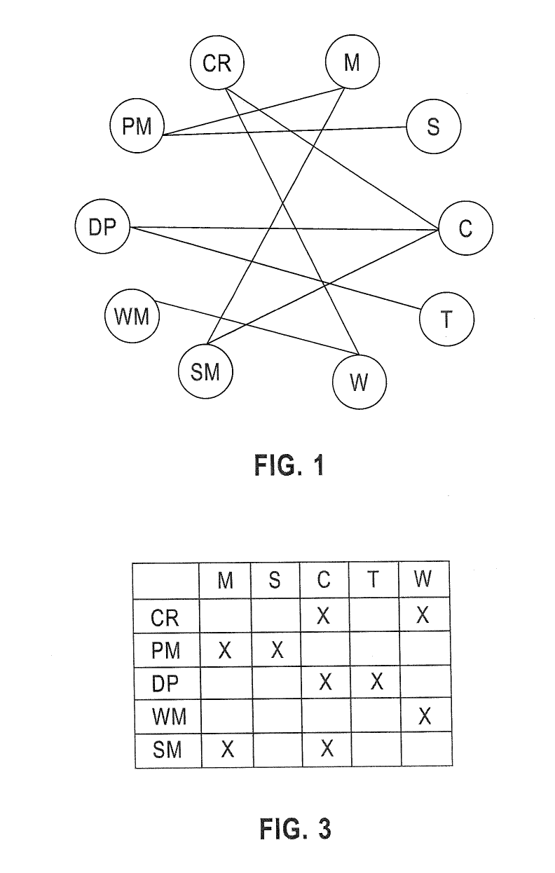

As a non-limiting example, and referring to FIG. 1, consider a food distribution business (Food Distributor) that has the following components: Customer Representatives (CR), Purchase Manager (PM), Delivery Planner (DP), Warehouse Manger (WM), and Salesmen (SM). The Food Distributor has a number of Suppliers (S), Customers (C), a Warehouse (W) and Trucks (T), and may be may be assumed to have access to Futures and Options Markets (M) exchanges to help in adjusting pricing.

Customer Representatives (CR) receive requests from Customers (C) to deliver food items on certain days of the week by a certain time. The Purchase Manager (PM) orders food from Suppliers (S) and monitors the Futures and Options Markets (M). The Delivery Planner (DP) performs planning and prepares the schedules and itinerary for loading/unloading operations of the Trucks (T). The Warehouse Manager (WM) is responsible for receiving food from Suppliers (S), stocking it in the Warehouse (W), and for loading the Trucks (T) to deliver orders to the Customers (C). The Salesmen (S) are responsible for bringing in new customers (C) and retaining existing ones.

Assume that the Food Distributor is projecting to double its business in three years and increase profit to at least the industry average. To accomplish these goals the Food Distributor retains a consulting company represented by at least one consultant. First, the consultant draws a graph representing relationships between components of this business (see FIG. 1). Second, the consultant analyzes the relationships and identifies the following issues by interviewing company employees, each issue being located in a relationship between components.

(1) Customer Representatives—Customers: Assume that the CRs do not always offer substitutions if the W is out of a product. For example, if there is no 30% sour cream, CRs do obtain it from other sources in order to keep the customer, and 40% sour cream is not offered as a substitute. There is no automatic prompt in the company's existing software to encourage this.
(2) Customer Representatives—Customers: Retaining customer/product relationships. The CRs do not make a practice of checking a particular restaurants' order of a certain type of food against previous orders. So if a restaurant orders less than usual, the CRs cannot determine if the order is just to equalize a previously large order, or if a competitor is offering their customer a better deal for that particular type of food.
(3) Customer Representatives—Warehouse: The CR uses the previous day's warehouse information, but when the CR takes an order the CR does not always know whether the ordered item was already picked up by another CR. Because the CRs do not always update the W record, it should be updated automatically.
(4) Purchase Manager—Supplier: There is a discrepancy between what the customer is being promised and what is deliverable. This would be remedied if the PM had access to a document with the scheduled delivery of products from the suppliers.
(5) Purchase Manager—Customer: The PM does not have a season-adjusted estimation of orders.
(6) Purchase Manager—Markets: The PM does not have a tool that correlates a statistical spread between market future prices and suppliers' prices (e.g., a particular supplier's future price is $10, but the market future price is $8, and the average industry spread is $1.50.) That is, the PM does not always know his bargaining position.
(7) Delivery Planner—Customer: The DP does not have a tool that interactively generates the delivery schedule. For example, assume that a certain customer requests that a product delivery be made at 10:00 AM. The tool would allow the DP to use a “what if” projection program that would aid in increasing the number of customers served per truck if this particular customer would accept a delivery between 9:30 AM and 11:00 AM. An experienced DP may do this even without special software if he is allowed to have direct contact with the customers. A DP-Customer negotiation may include a discount as an incentive to the customer to accept the delivery at other than 10:00 AM.
(8) Delivery Planner—Truck Drivers: There is no coordination between the DP and the truck drivers. For example, the truck drivers sometimes do not call when there are unexpected detours and, as a result, the DP is unable to notify the customer(s) of the delivery delay.
(9) Warehouse Manager—Warehouse: The package tagging system is not adequate to handle the growing number of items stacked in the warehouse. There is no equipment to read tags from a distance.
(10) Sales Manager—Market. The SM does not have a tool that correlates the statistical spread between market future prices and suppliers' prices. The SM is not allowed to promise prices to customers that would yield under the desired profit goal. Considering the market, the pricing is not sufficiently flexible.
(11) Sales Manager—Customer: The SM uses a “mixing” technique where some items are sold below the purchase price in order to retain the customer while some items are sold with a very high mark up. However, the Salesmen do not properly balance the discount/markup mix to maintain profits.

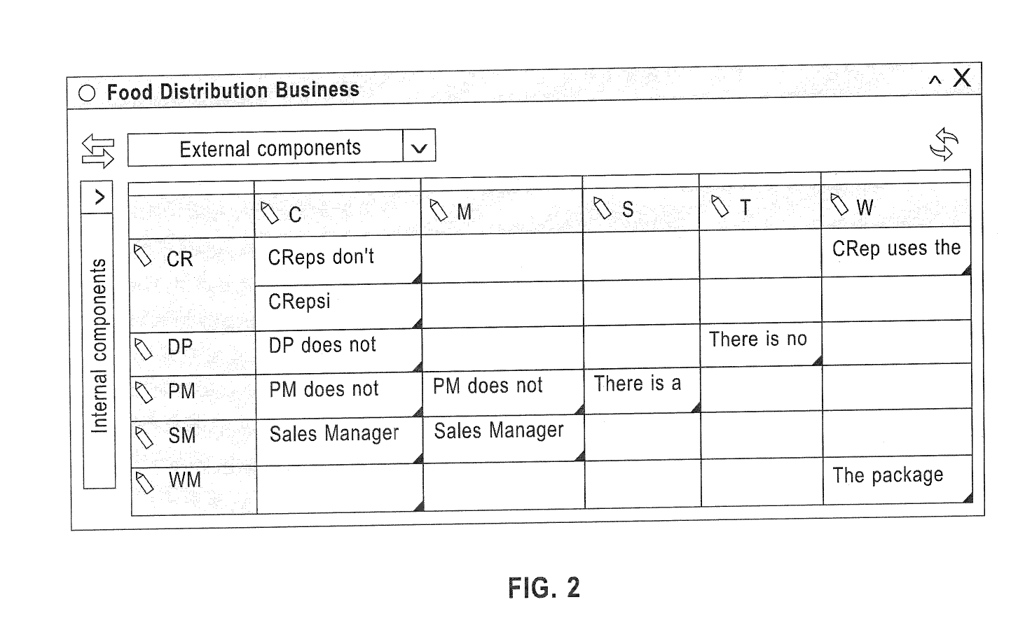

The foregoing example has been constructed so that there are no relations between two components that are both to the left of a vertical axis in the diagram of FIG. 1, and no relations between two components that are both to the right of the vertical axis. As such, the same information can be re-visualized in as in table shown in FIG. 2, as well as in the matrix of FIG. 3 (“Original View”), with those components on the left becoming row headers and those on the right as column headers. The table has been drawn in FIG. 3 to show an X where relations exist in the diagram of FIG. 1 and the model. However, it could equally display text in each cell as in FIG. 2, with the text being the description, as in the above list, of the one or more issues in the relationship between the pair of components represented by the cell. Note in FIG. 2 that the text shown in the cells is shortened from that described above in items 1 through 11.

The entity relationship diagram (FIG. 1) may thus be presented as the matrix of FIG. 3, where row headers are “internal” business components (e.g., CR, PM) and column headers are “external” business components (e.g., M, S, C).

To facilitate inter-component relationship analysis, the business consultant would break the matrix in FIG. 3 into sets of smaller matrices with non-repeating rows and select a set (or sets) of views with a minimal number of common columns.

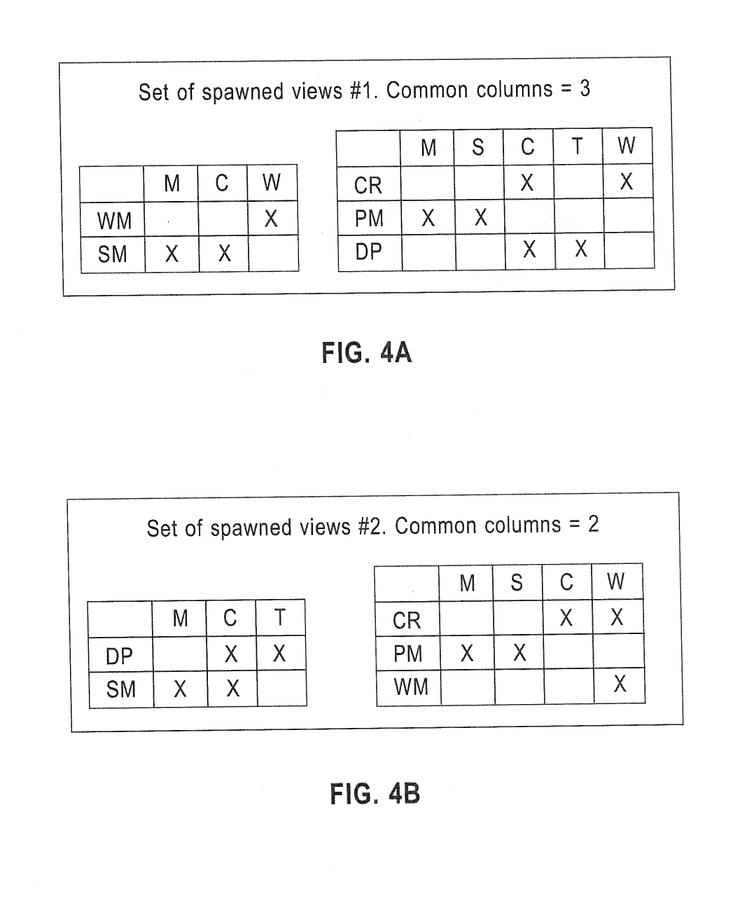

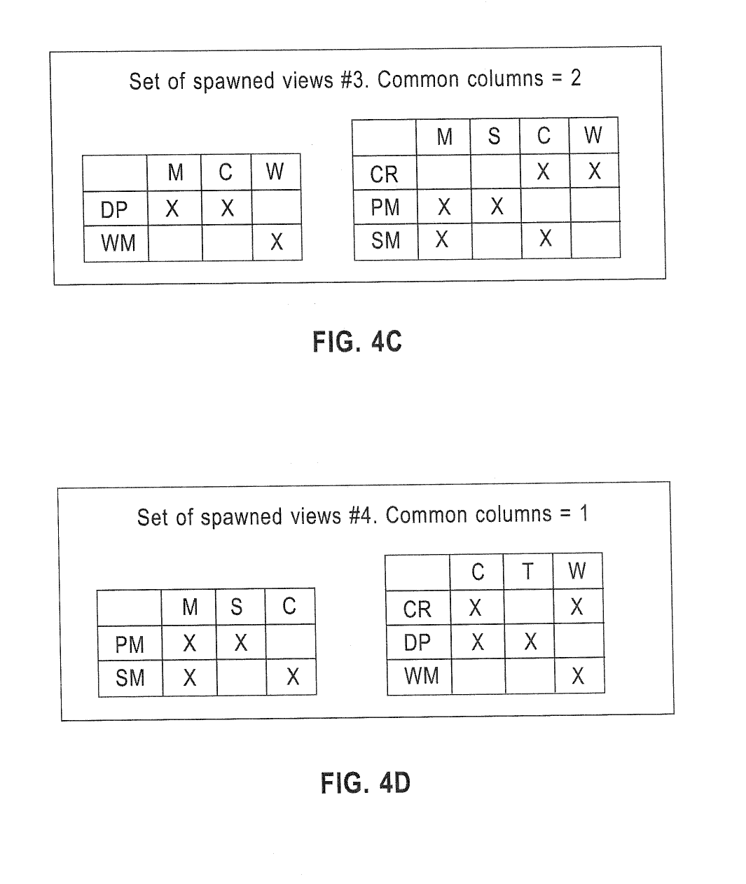

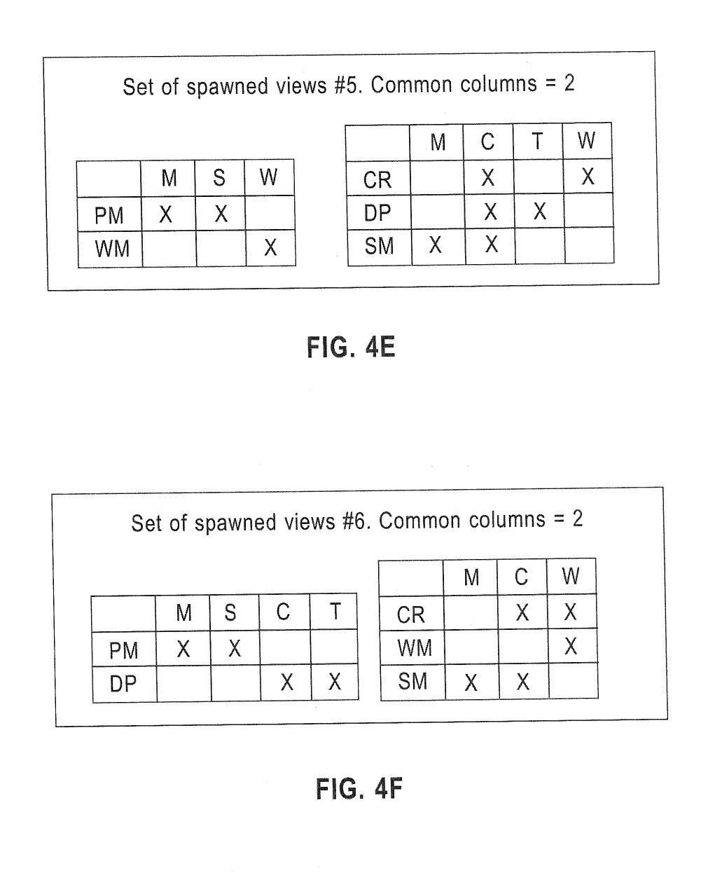

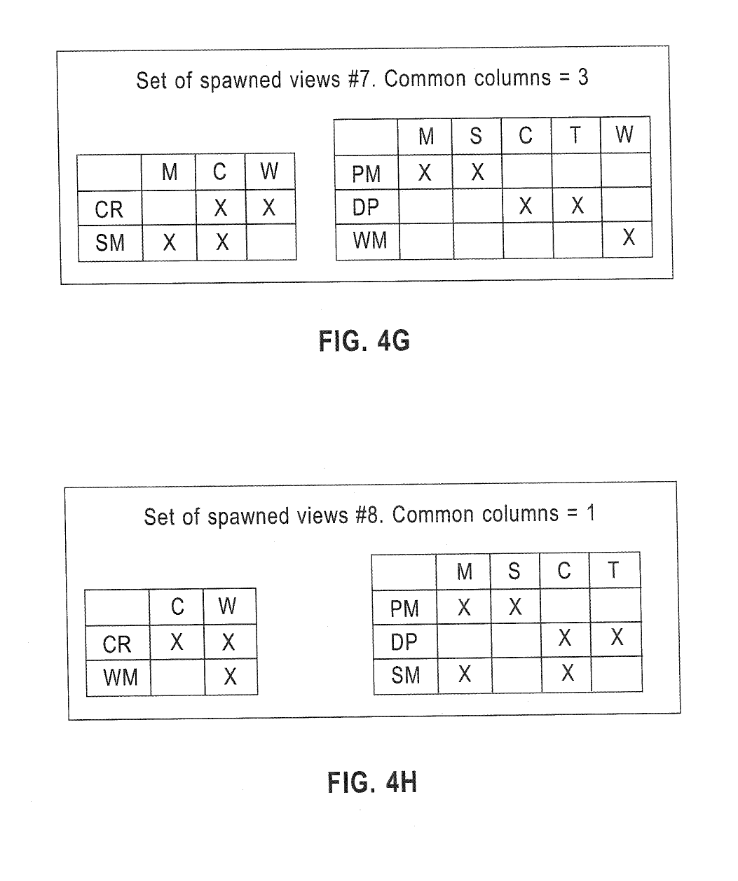

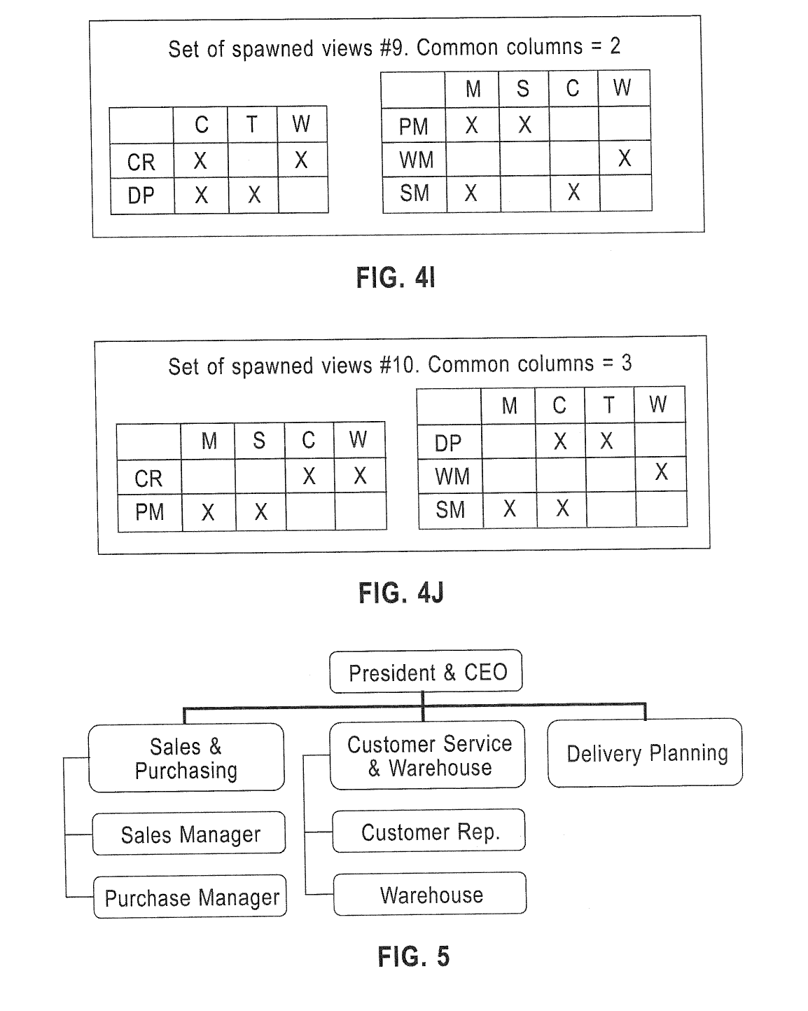

If the number of rows (m) in the smaller matrices is 2, or at least not smaller than 2, the result of spawning smaller views off of the matrix in FIG. 3 would operate as shown in FIGS. 4A-4J. Note that sets #4 and #8 (FIGS. 4D and 4H) have the smallest number of common columns.

As was made evident above, the Purchase Manager (PM) and Sales Manager (SM) are in the same views, as are the Customer Representative (CR) and Warehouse Manager (WM). The Delivery Planner (DP) is independent; that is the move of the DP from one view to another does not change the number of common columns among views. Thus, the Purchase Manager and the Sales Manager may be placed in one business unit. The same is true of the Customer Representative and the Warehouse Manager. The role of the Delivery Planner is independent of both business units, and thus the DP may be a stand-alone unit. Accordingly, a recommended organization chart may be as shown in FIG. 5.

In fact, the Sales Manager and the Purchase Manager may be seen to have conflicting interests. In the exemplary distribution business it is common practice that Sales Manager compensation is solely sales-based, while the Purchase Manager compensation is linked to the profit of the company. Thus, this conflict of interest may be balanced if they operate under the same management umbrella.

The exemplary embodiments of this invention are now described in even further detail.

As employed herein a view in a set of views differs from a view as defined in database theory, where a view is a virtual table composed of the result set of a query. The method of creating a set of views in accordance with the exemplary embodiments of this invention differs from the selection of data from a database in at least two ways: first, in defining “views” and secondly, in selecting data.

(1) In a database, “a view” is constructed when the user selects particular columns by their names. For example, the following view, which has the name ABC, selects all data from columns A, B, and C from a table T1, which has columns A, B, C, D, F, G.

create view ABC on T1 as SELECT A, B, C FROM T1

The selection of columns A, B, and C is possible as a simple select query from an ABC view select * from ABC

(2) In a database, the query (shown below) selects data from the table T1 with the constraint on column values:

select A, B, C, D where A>0 and F is not null

In contrast to the database method described above, in accordance with the embodiments of this invention the creation of a set of views off of an existing view is intrinsically different from the process of selecting data out of a database. This is due to the fact that creation of a set of views does not use the names of model elements (column names for example), nor the content of the data.

Referring again to FIG. 3 (which shows the original view of the business model) it can be seen that in the case of a small number of rows, a simple enumeration is adequate to solve the combinatorial problem. But as the number of rows grows, it is preferred to use a formalized approach to achieve scalability.

Described now is a mathematical formulation.

Determining the most suitable set of views is a complex combinatorial problem. Consider a simple case where it is desired to obtain k=2 views, and the number of rows in the smaller view is m. Then, given that the overall number of rows in the table is n, the overall number of possible sets of views F is given by:

F=C(m,n)=n!/[(n−m)!m!].

For the example in FIG. 3 (n=5, m=2) and, therefore, F=C(2,5)=5!/[(5−2)! * 2!]=10. One can then rank these sets in order to select a most suitable one.

When the desired number of sets of views k is greater than 2, the problem becomes considerably more complex. One approach to solving this problem involves formulation of the problem within the framework of graph theory (of special importance here is the so-called problem of graph partitioning).

In this approach every party in the business model may be characterized by a node in a graph G. As noted above, the parties in the business model are subdivided into two categories. Accordingly, the nodes in the graph that belong to the first category will be called internal. These nodes correspond to the rows in the business model table (PM, WM, SM, CR and DP in the example above). Similarly, the nodes in the graph that belong to the second category will be called external. These nodes correspond to the columns in the business model table (M, S, C, T, and W in the example above). Note that these nodes can be represented as a bi-partite graph of type shown in FIG. 1, with edges connecting some of the internal nodes (those on the left in this example) and external nodes (those on the right in this example). An edge reflects some form of interaction between nodes (in this case, between parties in the business model) that are of primary interest. There are no edges connecting nodes that are in the same category. Every edge has an associated weight (denote by w, the weight associated with the i-th edge). This weight reflects the importance of the edge. For example, in the embodiment discussed above (see FIG. 1), if there are 10 issues of record between PM and M, and only 2 issues of record between PM and S, then weights wᵢ are assigned to the corresponding edges in a ratio 5:1.

An important element to consider is the subdivision of the internal nodes into k categories so as to ensure that each of these categories are associated with a relatively small number of external nodes, and that the external nodes corresponding to different categories tend not to overlap. In particular, denote the desired internal categories by L₁, L₂, . . . , Lₖ (where the letter L reflects the fact that the internal nodes are shown on the left side of the bi-partite graph). Accordingly, subdivide the external nodes into k categories: denoting them R₁, R₂, . . . , Rₖ (the letter R stands for “right”). It is desirable that the categories of the internal nodes do not intersect, however this need not be the case for the external nodes. In this way it is possible to obtain associated pairs of categories (Lᵢ, Rᵢ), for r=1, 2, . . . , k, and this categorization may be defined as a partition P. Denote the set of edges emanating from nodes in the i-th category

Lᵢ by Sᵢ. The fact that an edge e belongs to this set is denoted e⊃Sᵢ. Now denote by Sᵢ₀ the subset of edges that connect nodes in the category Lᵢ to nodes in the corresponding category Rᵢ. Similarly denote by Sᵢ₁ the subset of edges that connect nodes in the category Lᵢ to nodes outside the corresponding category Rᵢ. In a similar way, define the set of edges pointing to one of the nodes in the category Rᵢ by Dᵢ (in this notation one may consider S and D as representing “source” and “drain” categories). Next denote by Dᵢ₁ the subset of edges pointing to one of the nodes in Rᵢ but originating in one of the nodes outside Lᵢ.

It then becomes possible to introduce a measure of discrepancy between the given partition P and a “perfect match” situation in terms of the measure such as by:

$$Z = {\sum }_{i = 1}^{k} ( \frac{{\sum }_{e ⋐ {S}_{i 1}} {w}_{e}}{{\sum }_{e ⋐ {S}_{i}} {w}_{e}} + \frac{{\sum }_{e ⋐ {D}_{i 1}} {w}_{e}}{{\sum }_{e ⋐ {D}_{i}} {w}_{e}} ) \qquad ( 1 )$$

It can be seen that Z is always non-negative; it will be close to zero for the case of “perfect match” and will deviate from zero as the amount of mismatch grows.

A problem to be solved is, therefore, to find a partition P that minimizes the measure Z, possibly under some constraints:

### Minimize {Z}

Subject to C₁, C₂, . . . , (2)

where C, represent some constraint. For example, one constraint may be to avoid partitions that contain pairs (Lᵢ, Rᵢ) in which every component is “small” in size. Similarly, since a given partition P produces “windows” through which a user would interact with the overall model table, it may be desired to avoid views of very large size. Thus, a constraint may be imposed that prevents the components Lᵢ and Rᵢ from becoming too large in size simultaneously, for every pair (Lᵢ, Rᵢ).

In practice, it is difficult to specify the number of categories k a-priori, since the best number of categories typically depends on a data-driven configuration of internal and external nodes. One may then solve the problem for k=1, 2, . . . , stopping at some point where a further increase of the number of categories does not lead to a strong reduction of the measure Z.

The described problem of “bi-partite graph partitioning” occurs in other settings, though formulations and constraints vary depending on the specifics of the application. Recently this type of problem has become relevant in conjunction with the so-called problem of document clustering. More specifically, if one considers the internal nodes as documents and the external nodes as words contained in these documents (the weight wᵢ then represents the number of times that a particular word is mentioned in a particular document), it can be seen that clustering documents into groups by subject (so that each group is associated with its own group of words) leads to a problem of this type. For example, a paper “Bipartite graph partitioning and data clustering” by Zha et al. (Conference on Information and Knowledge Management, 2001) considers the document clustering problem and introduces a recursive partitioning methodology to solve it.

The exemplary embodiments of this invention introduce the application area (related to consulting tools for management of a business model), where the problem of bi-partite graph partitioning becomes relevant. The constraints in the business consulting problem of interest differ significantly from those used in document clustering. For example, in the embodiment discussed above one may demand a-priori that if a selected view contains the column T (trucks) then it must also contain the column W (warehouse), as an analyst working on the related issues may prefer to see these two columns in the same view. Another type of constraint may be related to sizes of the resulting views, as mentioned earlier. It is these and similar types of constraints that make this particular problem different from the document-related problem mentioned above, and potentially more difficult to solve.

The problem may also be generalized in another direction, namely, one may also consider interactions among the internal nodes (or among the external nodes). This type of problem may be placed in the “bi-partite graph partitioning” form by creating, for example, artificial pairs of nodes instead of a single node, and then positioning one of the node pair members in the internal part and the other in the external part.

Another way in which this problem can be generalized is by introducing asymmetric weights. For example, the approach described above assumes that the weights wₑ are edge-specific; in other words, if an edge (relationship) exists between a pair of nodes (u,v) where u is an internal node and v is an external one, then there is only one weight wₑ that corresponds to this edge. In practice, one can use the edge weights to regulate level of association between internal and external nodes. By assigning a very high weight to a given edge it makes it more likely that (u,v) corresponding to the given edge will be located in the same view. In contrast, the asymmetric weights can be used, for example, to assign a higher weight to an edge when it is counted as incoming edge to v as opposed to the case when it is counted as an outgoing edge from node u. One can define this pair of weights corresponding to edge e by (w_{e,s} w_{e,d}). The discrepancy measure corresponding to partition P generalizes to

$$Z = {\sum }_{i = 1}^{k} ( \frac{{\sum }_{e ⋐ {S}_{i 1}} {w}_{es}}{{\sum }_{e ⋐ {S}_{i}} {w}_{es}} + \frac{{\sum }_{e ⋐ {D}_{i 1}} {w}_{ed}}{{\sum }_{e ⋐ {D}_{i}} {w}_{ed}} ) \qquad ( 3 )$$

One result is that there can be granularity in the weights that enables one to more closely regulate the level of desired grouping among internal nodes and/or internal nodes.

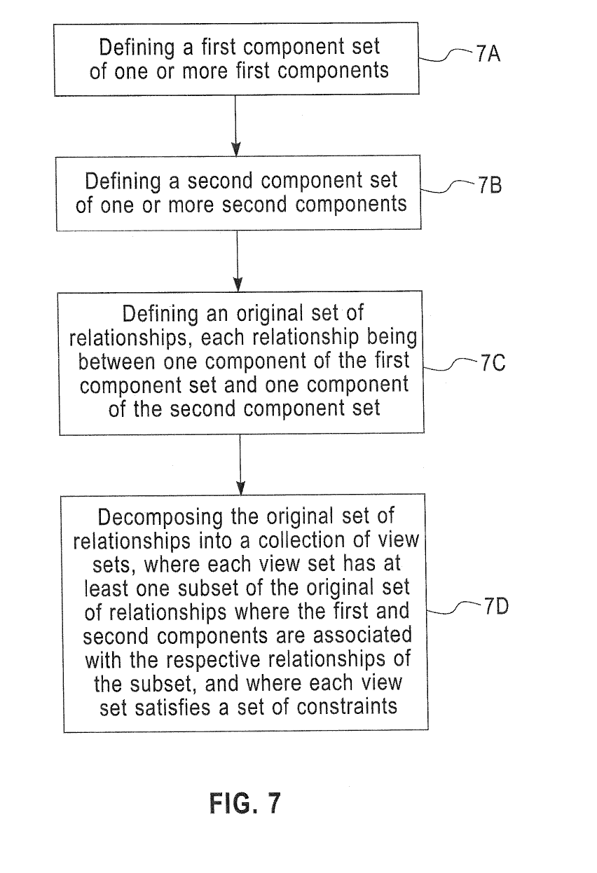

Based on the foregoing description, it should be appreciated that an aspect of the exemplary embodiments of this invention is a method to create view sets. Referring to FIG. 7, the method includes in Block 7A defining a first component set of one or more first components; in Block 7B defining a second component set of one or more second components; and in Block 7C defining an original set of relationships, each relationship being between one component of the first component set and one component of the second component set. The method further includes, in Block 7D, decomposing the original set of relationships into a collection of view sets, where each view set has at least one subset of the original set of relationships where the first and second components are associated with the respective relationships of the subset, and where each view set satisfies a set of constraints.

In this method each view set satisfies at least the following constraints: none of the relationships in the original set of relationships is absent from any view set, and each view set has at least one subset of the original set of relationships.

In this method a particular relationship may have an associated weight.

In this method a view set has a minimal number of shared relationships between subsets.

In this method one constraint relates to a size of at least one of the first component set and second component set in each subset of the original set of relationships, and another constraint relates to a number of subsets of relationships in a view set.

In this method components of the first set of components and the second sets of components, and the original set of relationships, may be elements of a business model, where in the business model the first set of components and the second components are business functions in a business, and where a relationship between a component of the first set of components and a component of the second set of components is an interaction between the respective business functions. The business functions may comprise at least two of: customer representative, purchase manager, delivery planner, warehouse manager, sales manager, futures and options market, supplier, customer, trucks and warehouse.

The method may further include visualizing the view sets for a user, such as a business consultant.

As should be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable software program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As such, various modifications and adaptations may become apparent to those skilled in the relevant arts in view of the foregoing description, when read in conjunction with the accompanying drawings and the appended claims. As but some examples, the use of other similar or equivalent mathematical expressions may be used by those skilled in the art. However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method to create view sets, comprising:
defining a first component set of one or more first components;
defining a second component set of one or more second components;
defining an original set of relationships, each relationship being between one component of the first component set and one component of the second component set; and
decomposing the original set of relationships into a collection of view sets, each view set having at least one subset of the original set of relationships where the first and second components are associated with the respective relationships of the subset, and each view set satisfies a set of constraints.

2. The method as in claim 1, where each view set satisfies at least the following constraints:
none of the relationships in the original set of relationships is absent from any view set, and each view set has at least one subset of the original set of relationships.

3. The method as in claim 1, where a particular relationship has an associated weight.

4. The method as in claim 1, where a view set has a minimal number of shared relationships between subsets.

5. The method as in claim 1, where a constraint relates to a size of at least one of the first component set and second component set in each subset of the original set of relationships.

6. The method as in claim 1, where a constraint relates to a number of subsets of relationships in a view set.

7. The method as in claim 1, where components of the first set of components and the second sets of components, and the original set of relationships, are elements of a business model.

8. The method as in claim 7, where in the business model the first set of components and the second components are business functions in a business, and where a relationship between a component of the first set of components and a component of the second set of components is an interaction between the respective business functions.

9. The method as in claim 8, where the business functions comprise at least two of: customer representative, purchase manager, delivery planner, warehouse manager, sales manager, futures and options market, supplier, customer, trucks and warehouse.

10. The method as in claim 1, further comprising visualizing the view sets.

11. A system, comprising:
at least one memory storing a first component set of one or more first components and a second component set of one or more second components; and
at least one data processor coupled with the at least one memory and configurable in accordance with a stored software program to define an original set of relationships, where each relationship is between one component of the first component set and one component of the second component set, said at least one data processor being further configurable to decompose the original set of relationships into a collection of view sets, where each view set has at least one subset of the original set of relationships, where the first and second components are associated with the respective relationships of the subset, and each view set satisfies a set of constraints.

12. The system as in claim 11, where each view set satisfies at least the following constraints: none of the relationships in the original set of relationships is absent from any view set, and each view set has at least one subset of the original set of relationships.

13. The system as in claim 11, where a particular relationship has an associated weight.

14. The system as in claim 11, where a particular relationship has a pair of asymmetric weights.

15. The system as in claim 11, where a view set has a minimal number of shared relationships between subsets.

16. The system as in claim 11, where one constraint relates to a size of at least one of the first component set and second component set in each subset of the original set of relationships, and where another constraint relates to a number of subsets of relationships in a view set.

17. The system as in claim 11, where components of the first set of components and the second sets of components, and the original set of relationships, are elements of a business model, where in the business model the first set of components and the second components are business functions in a business, and where a relationship between a component of the first set of components and a component of the second set of components is an interaction between the respective business functions.

18. The system as in claim 17, where the business functions comprise at least two of: customer representative, purchase manager, delivery planner, warehouse manager, sales manager, futures and options market, supplier, customer, trucks and warehouse.

19. The system as in claim 11, further comprising a user interface configured to present the view sets to a user of the system.

20. A computer-readable memory medium that stores a software program, the execution of which results in performing operations comprising:
defining a first component set of one or more first components;
defining a second component set of one or more second components;
defining an original set of relationships, each relationship being between one component of the first component set and one component of the second component set; and
decomposing the original set of relationships into a collection of view sets, each view set having at least one subset of the original set of relationships where the first and second components are associated with the respective relationships of the subset, and each view set satisfies at least the following constraints: none of the relationships in the original set of relationships is absent from any view set, and each view set has at least one subset of the original set of relationships.

21. The computer-readable memory as in claim 20, where a view set has a minimal number of shared relationships between subsets.

22. The computer-readable memory as in claim 20, where a constraint relates to a size of at least one of the first component set and second component set in each subset of the original set of relationships, and where another constraint relates to a number of subsets of relationships in a view set.

23. The computer-readable memory as in claim 20, where components of the first set of components and the second sets of components, and the original set of relationships, are elements of a business model.

24. The computer-readable memory as in claim 23, where in the business model the first set of components and the second components are business functions in a business, and where a relationship between a component of the first set of components and a component of the second set of components is an interaction between the respective business functions.

25. The computer-readable memory as in claim 24, where the business functions comprise at least two of: customer representative, purchase manager, delivery planner, warehouse manager, sales manager, futures and options market, supplier, customer, trucks and warehouse.
